(19) United States
(12) Patent Application Publication
(10) Pub. No.: US 2013/0179016 A1
(43) Pub. Date: Jul. 11, 2013

(54) Power Assisted Vehicles

(71) Applicant: Stephen William Gale, Richmond (AU)

(72) Inventor: Stephen William Gale, Richmond (AU)

(21) Appl. No.: 13/684,358

(22) Filed: Nov. 23, 2012

Related U.S. Application Data
(63) Continuation-in-part of application No. 12/828,499, filed on Jul. 1, 2010, now abandoned.

(30) Foreign Application Priority Data
Jul. 2, 2009 (AU) 2009903110
Jul. 20, 2009 (AU) 2009100700

(51) Int. Cl. B62M 6/50; B62K 11/00

(52) U.S. Cl. CPC B62M 6/50; B62K 11/00
USPC 701/22

(57) ABSTRACT

This invention relates to power assisted vehicles (10) and in particular to vehicles of the type which use electrically powered motors (13) to assist in the propulsion, of the vehicle. The control system (14) for a power assisted vehicle (10) having an electric motor (13), said control system (14) including: an accelerometer-based tilt sensor (16) augmented with an input from a velocity source (46) to determine the inclination of said vehicle (10), a manual input variably adjustable sensor (23) for detecting in a non-contact manner manual propulsion input, to said vehicle (10), by sensing the rotation speed of a rotating portion of said vehicle (10); and said control system (14) being adapted to control the power supplied to said motor (13) and therefore the power assistance provided to said vehicle (10) by said electric motor (13) in accordance with, the inclination or pitch of said vehicle (10) as sensed by said augmented accelerometer-based tilt sensor (16) and the manual propulsion input from said manual propulsion sensor (23).

### CROSS REFERENCE TO RELATED APPLICATIONS

This application is a continuation-in-part application of U.S. patent application Ser. No, 12/828,499 filed on Jul. 1, 2010 now pending and incorporated by reference herein.

### TECHNICAL FIELD

This invention relates to power assisted vehicles and in particular to vehicles of the type which use electrically powered motors to assist in the propulsion of the vehicle. More particularly, the present invention relates to electrically powered bicycles or other similar vehicles such as tricycles which are designed to he propelled by human power but which also include an electric motor to assist in the propulsion of the vehicle or to he a substitute for the normal rider-propulsion of the bicycle.

### BACKGROUND ART

Motorized bicycles normally are designed to be pedalled by a rider and in addition include a small electric motor or internal combustion engine to assist in propelling the bicycle either when the rider is pedalling or not. Thus a bicycle can be propelled by the motor alone or only if the rider pedals as well. Most commonly, motorized bicycles include electric DC motors which are powered by batteries on the bicycle. Motorized bicycles however are also usually capable of being powered by pedals alone if required. Motorized bicycles are usually similar in design to normal unpowered bicycles so as to be of relatively light weight but have an arrangement for supporting the motor and batteries for the motor. Power can be supplied to assist in propulsion of the bicycle either continuously or under throttle control so that power assistance can be provided where required.

If however the motorized bicycle has a manual motor bike style throttle, it is common for most people using such a bicycle to use the throttle in one of two positions, either fully on or fully off. This tends to mean that they waste power unnecessarily on level terrain. As a result the bicycle is required to carry a larger, heavier and more expensive battery than is actually required. Thus if the rider reverts to manual pedalling, the rider has to propel aft increased load.

On ascending a hill the rider can use the throttle to control the power applied by the motor to increase the assistance provided by the electric motor however it is often difficult for the rider to control that power efficiently. One system aimed at varying the output of the motor for assistance in climbing a hill to increase efficient use of the power provided by the motor uses a strain gauge device to determine the torque applied by the rider to the hack wheel. This type of system however does not actually sense the effort needed to ascend the hill and requires a relatively delicate component to be placed in a vulnerable location on the bicycle rear wheel. In addition this type of system is difficult to retrofit to existing bicycle frames as the sensor is required to he mounted “in series” with the hub sprocket of the rear wheels.

It would be desirable if a power assisted vehicle such as a bicycle was available which used an electric motor and which more efficiently made use of the available energy from the battery which powers the motor. It would be further desirable to have a power assisted vehicle in which, power assistance provided by the motor is adjusted automatically.

### SUMMARY OF THE INVENTION

The present invention provides in one aspect although not necessarily the broadest aspect, a control system for a power assisted vehicle having an electric motor, said control system including: an accelerometer-based tilt sensor augmented with an input front a velocity source to determine the inclination of said vehicle; a manual input variably adjustable sensor for detecting in a non-contact manner manual propulsion input to said vehicle, by sensing the rotation speed of a rotating portion of said vehicle: and said control system being adapted to control the power supplied to said motor and therefore the power assistance provided to said vehicle by said electric motor in accordance with the inclination or pitch of said vehicle as sensed by said augmented acceleration-based tilt sensor and the manual propulsion input from said manual propulsion sensor.

The term “power assisted vehicle” as used herein includes a vehicle which can he powered by human input such as a bicycle or a tricycle which is powered by being ridden by a rider pedalling and which includes a motor to assist in or provide the sole or primary power for propelling the vehicle. The term “MEMS sensor” as used throughout the specification includes any miniature micro-electrical mechanical system sensor typically a solid, state accelerometer based sensor which can sense tilt or an inclination.

The term “pitch” as used herein comprises the inclination of a substantially upright vehicle in the fore and aft direction, and may be positive or negative depending upon whether the vehicle is travelling up a slope or incline or down a slope or incline.

Power is typically provided, by a battery and the supply voltage and the current to the motor is automatically regulated by the control system. Where the vehicle is a bicycle, a constant effort from a bicycle rider will maintain an acceptable speed irrespective of terrain. A power assisted bicycle of this type will therefore not require a manual throttle and will achieve maximum and consistent utilisation of a given battery's capacity. As current drawn by the motor varies in accordance with the load, on the motor, power supply to the motor is effectively controlled by controlling the voltage applied to the motor.

Preferably, the accelerometer-based tilt sensor may be a multi-axis MEMS sensor for sensing acceleration in at least two axes in a coordinate system to determine the inclination of said vehicle. The augmented input from the velocity source may be converted to physical acceleration information for augmenting the multi-axis MEMS sensor to determine the inclination of said vehicle.

Preferably the power input required to be supplied to the motor to assist movement of the vehicle up an incline or slope is calculated or determined from the output signal's from the sensor and the control system includes a comparator for comparing-the power drawn by the motor with the calculated or determined power input required. Preferably the comparison provides an error signal for adjusting the power supplied to the motor. Preferably the control system includes a motor controller which receives the error signal and varies the power supplied from a battery to the motor in accordance with the error signal.

Preferably the control system includes a method for compensating the effects of physical acceleration, from the MEMS accelerometer used to detect the angle of inclination. Preferably the control system includes means for filtering and processing the output signal's from the sensor to remove vibration signals due to rough terrain or the rider's body movement. Preferably the output from the filtering and processing means comprising the filtered and processed output signal/s from the sensor is scaled to provide a measurement of the power required to be applied, by the motor which is in proportion to the incline or slope upon which the vehicle is travelling. Preferably the scaling of the filtered and processed output signal's from the sensor is undertaken by a scaler which applies a constant gain term to the output signals from the filtering and processing means for application as an input to the comparing means for comparison with the power drawn by said motor to provide the error signal. The constant gain term may be varied depending upon the average weight of the vehicle and/or the average weight of the rider of the vehicle. The gain term may also be varied in accordance with, the intended speed of the vehicle and/or efficiency of the motor. Finally the gain term may be adjusted according to the riders desire to limit the amount of assistance he or she wishes to receive.

Preferably, the manual input variably adjustable sensor may be an induction sensor mounted in an infinitely variable and adjustable housing in a manner that allows the rotating portion to affect the properties of the induction sensor in a variety of different mounting positions. Preferably, the induction sensor may be an induction coil mounted in a ferrite core, with an open end to permit the induction coils inductance and any variation in inductance to be altered by the rotating portion.

Preferably, the control system may further include a switch for turning the control system on and off. Wherein depressing the switch for a finite period of time may allow the control system to automatically determine the mounting angle of the MEMS sensor. Preferably, the control, sensor may further include determining the mounting orientation of the MEMS sensor by a user raising the front wheel of the vehicle to a near vertical position to allow the control system to select the correct orientation for the vehicle.

Preferably an offset can be provided to the motor controller whereby power may be supplied to the motor to provide power assistance to the vehicle when it is not travelling up an incline or slope.

The present invention in a further aspect provides a manually propelled power assisted vehicle having a control system as described above. The control system may include a manual input sensor which, senses manual propulsion input to the vehicle and the control system, controls the supply of power to the motor in accordance with the output of the manual input sensor. Preferably the control system only provides power to the motor when there is manual, propulsion, input to the vehicle.

In accordance with a further aspect, the present invention provides a power assisted bicycle or tricycle, said bicycle or tricycle having at least a front wheel and a rear wheel, pedals for application of a pedalling force to at least one of said wheels for manually propelling said bicycle or tricycle, an electric motor on said bicycle or tricycle for providing supplementary drive to one of said wheels, and a control system for controlling the power supply to said electric motor, said control system comprising: an accelerometer-based tilt sensor augmented with an input from a velocity source to determine the inclination of said bicycle or tricycle in a fore and aft direction to thereby sense whether said bicycle or tricycle is climbing an incline, travelling with no inclination on level ground, or moving down an incline and the degree of said inclination; a pedalling sensor for sensing the rotation of a pedal assembly of said bicycle or tricycle; and a motor controller for controlling power supply to said electric motor, said, motor controller being adapted to vary the power supply to said motor and therefore the power assistance provided to said bicycle or tricycle by said motor in accordance with the inclination of said bicycle or tricycle as sensed by said augmented accelerometer-based tilt sensor and the output of the pedalling sensor when pedalling is sensed.

Preferably, the accelerometer-based tilt sensor may be a multi-axis MEMS sensor far sensing acceleration in at least two axes in a coordinate system to determine the inclination of said vehicle. The augmented input from the velocity source may be converted to physical acceleration information for augmenting the multi-axis MEMS sensor to determine the inclination of said vehicle.

An error signal is suitably derived from a comparison between the power required to be provided to the motor as calculated from the output from the augmented inclination sensor and the power drawn by the motor. Typically the motor controller provides a pulse width modulated power signal to the motor and the pulse width of the signal is varied in accordance with the error signal.

Means may be provided for providing an offset, signal to the motor controller whereby the motor controller can apply a signal to the motor when the bicycle or tricycle is travelling on level ground as sensed by the sensor.

Preferably, the sensor may provide an output signal, and wherein said control system includes means for filtering and processing said output, signal for filtering external vibration signals from said output signal. The control system may include means for scaling said filtered and processed output signal from said sensor. The scaling means may scale said filtered and processed signal from said sensor in accordance with a gain term determined by one or more of the average weight of the bicycle or tricycle, the average weight, of the rider of the bicycle or tricycle, the intended speed, of the bicycle or tricycle and efficiency of the motor. The control system may further comprise a comparator for comparing said scaled filtered and processed signal from said sensor with power drawn by said motor to provide an output error signal and wherein said motor controller supplies power from said battery to said motor in accordance with said error signal.

Preferably, the pedalling sensor may be an induction sensor mounted in an infinitely variable and adjustable housing in a manner that allows the pedal assembly to affect the properties of the induction sensor in a variety of different mounting positions. Alternatively, the induction sensor may be an induction coil mounted in a ferrite core, with an open end to permit the induction coils inductance and any variation in inductance to be altered by the pedal assembly.

Preferably, the power assisted bicycle or tricycle may further include a switch for turning the control system on and off. Wherein, depressing the switch, for a finite period of time may allow the control system to automatically determine the mounting angle of the MEMS sensor. Preferably, the power assisted bicycle or tricycle may further include determining the mounting orientation of the MEMS sensor by a user raising the front wheel of the vehicle to a near vertical, position, to allow the control system to select the correct orientation for the vehicle.

In a further aspect, the present invention provides a method of providing power assistance to a vehicle having a power assistance electric motor comprising the steps of; a) sensing the inclination of said vehicle using an accelerometer-based tilt sensor augmented with an input from a velocity source; b) sensing the rotation of a pedal assembly using a pedalling sensor; and e) control ling the power supplied to said motor and therefore the power assistance provided to said vehicle by said electric motor in accordance with the inclination of said vehicle as sensed by said augmented accelerometer-based tilt sensor and the output of the pedalling sensor when pedalling is sensed.

Preferably, sensing the inclination, may further comprise using a multi-axis MEMS sensor for sensing acceleration in at least two axes in a coordinate system. The augmented input from the velocity source may be converted to physical acceleration information for augmenting the multi-axis MEMS sensor to determine the inclination of said vehicle.

The method further may include the step of comparing the power drawn, by the motor with the power input required to be supplied to the motor determined from an output signal or signals from, said sensor to provide an error signal, which governs the supply of power to the motor. The method may further comprise the step of scaling the output signal or signals from the sensor in accordance with one or more of the average weight of the vehicle, the average weight of the rider of the vehicle, the intended, speed of the vehicle and efficiency of the motor, and the preferences of the rider.

The method may further comprise the steps of sensing manual propulsion input to said vehicle and controlling the supply of power to the motor in accordance with the sensed manual input.

Typically the vehicle comprises a bicycle or tricycle.

### BRIEF DESCRIPTION OF THE DRAWINGS

Reference will now he made to the accompanying drawings which illustrate a preferred embodiment of the invention. The invention has been described in relation to a bicycle however it will be appreciated that the invention may be applied to other manually pedalled or propelled vehicles and thus the following description is not to be considered as being limiting on the scope of the invention. In the drawings:

FIG. 1 illustrates schematically a power assisted bicycle incorporating a control system, according to an embodiment of the invention;

FIG. 2 illustrates in block diagram form the method of determining the inclination of the bicycle the output of a MEMS based accelerometer and the forward velocity of the bicycle;

FIG. 3 illustrates in block diagram form the control system for the power assisted bicycle of FIG. 1;

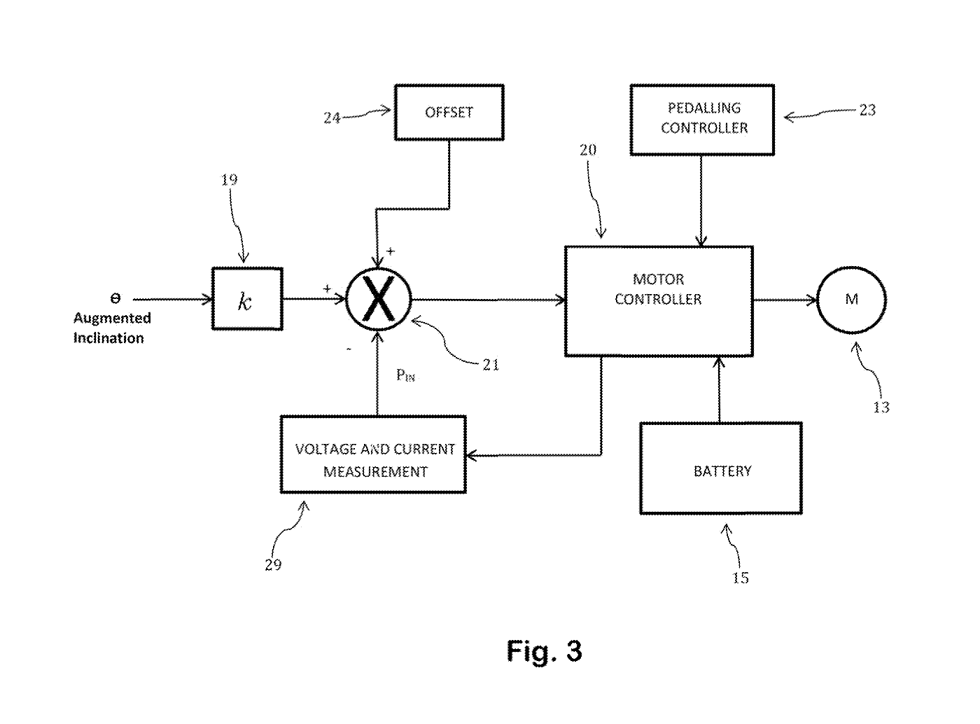

FIGS. 4 and 5 illustrates a pedalling sensor and mounting arrangement for the power assisted, bicycle of FIG. 1; and

FIG. 6 illustrates the mounting of the pedalling sensor of FIGS. 4 and 5.

### DETAILED DESCRIPTION OF THE PREFERRED EMBODIMENTS

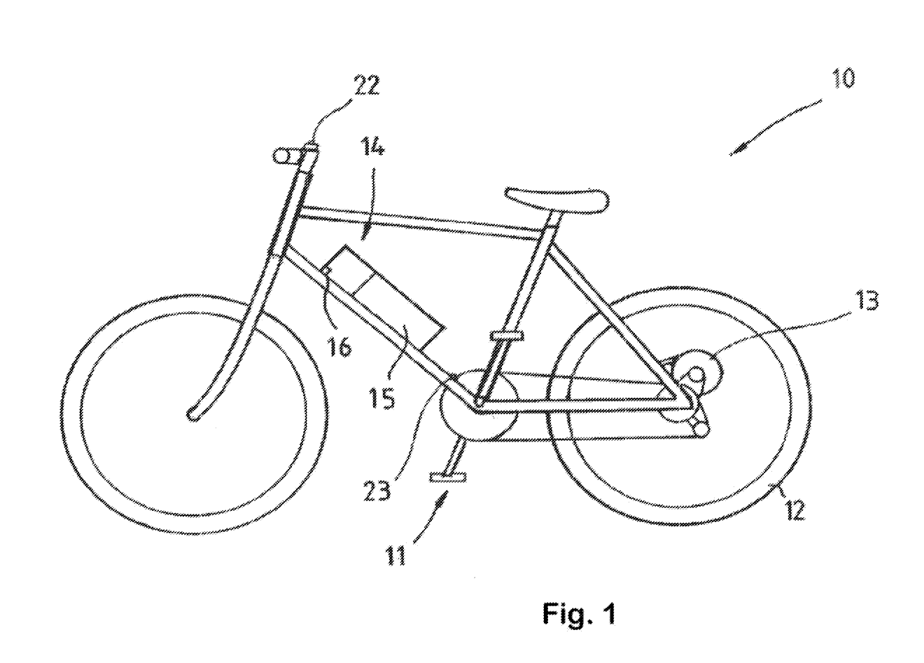

Referring to the drawings and firstly to FIG. 1 there is illustrated a typical, power assisted bicycle 10 provided with, a pedalling assembly 11 through which a manually provided pedalling power or force can be transmitted to the rear wheel 12 of the bicycle 10 to propel the bicycle 10. The bicycle 10 also includes an electric motor 13 for providing motive power assistance to the bicycle 10, the electric motor 13 typically being a brushless DC motor and being mounted by a suitable mounting or bracket on the rear forks of the bicycle 10, the motor 13 being coupled to the rear wheel 12 through any suitable transmission for example a belt or chain transmission for transmission of motive power to the rear wheel 12.

It will be appreciated that the bicycle 10 may be of many different designs other than that illustrated and may have either its rear wheel or front wheel equipped with the motor 13 for providing power assistance to the bicycle 1.0. The motor 13 may be mounted to the front or rear forks of the bicycle 10, may be a hub mounted motor or be capable of driving the front and/or rear wheels through any suitable transmission to assist in or provide at least part of the driving power for propulsion of the bicycle 10.

The bicycle 10 in accordance with an embodiment of the present invention is provided with a control system 14 for controlling the supply of power from a battery 15 mounted on the bicycle frame to the electric motor 13. The battery 15 may be any type of battery which is light weight and rechargeable with a long lifetime. For example, the battery may be a lead acid or alkaline battery, or nickel-cadmium, lithium-ion or any other rechargeable battery which provides a lightweight long life battery. In the present invention the battery is a lithium iron phosphate cells which have a minimum two year/1000 recharge, a weight of approximately 1.4 kg and a recharge time of less than an hour. The battery may alternatively be worn by the bicycles rider and connected with a removable plug.

A variety of acceleration based sensing devices are possible, it is important to have a means of sensing the inclination without, influence front the acceleration (or deceleration) normally encountered in typical riding. A pure gravity based sensing mechanism will confuse forward acceleration on a level surface with an incline and attempt to increase the power to the motor. This will create further acceleration and lead to an unstable motor control situation. Therefore augmentation of the accelerometer based sensor is provided to ensure the inclination information is based only on the inclination of the terrain, and is not affected by the positive or negative acceleration of the bicycle, in order to augment the acceleration-based tilt sensor an input from a velocity source is required. This may be derived in a number of ways from the motor controller 20 in the case of a brushless motor, or alternatively front a tachometer attached to the motor 13. The augmented acceleration sensor is therefore able to determine the inclination of the bicycle in a tore and aft direction to thereby sense whether the bicycle is climbing an incline, travelling with no inclination on level ground, or moving down an incline and the degree of said inclination.

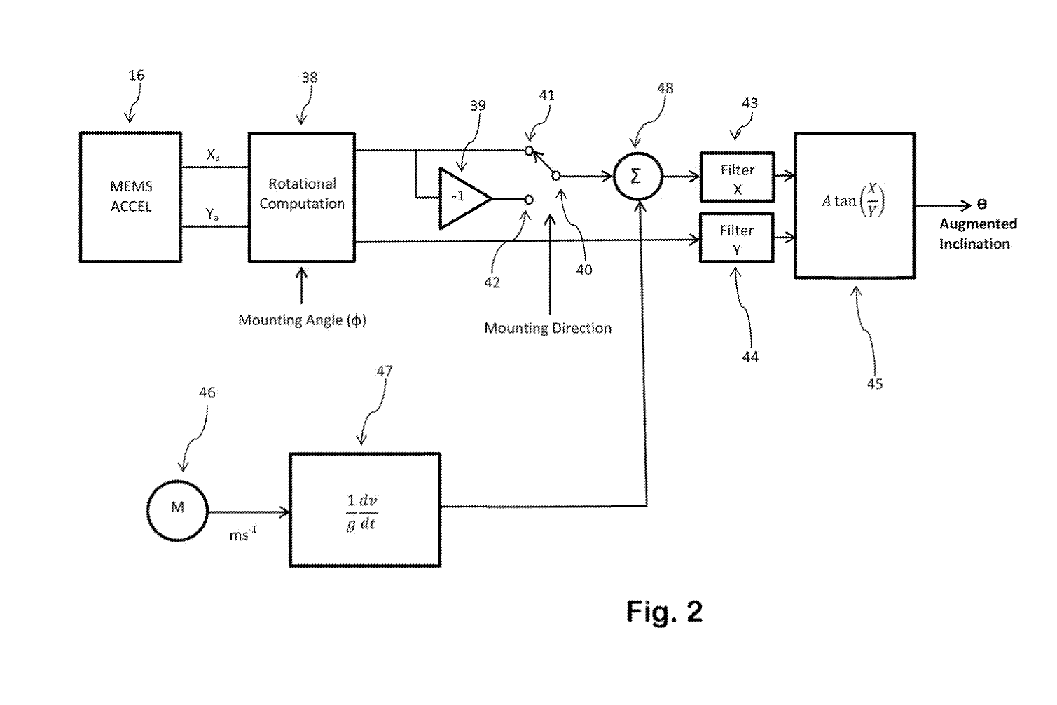

The control system 14 includes as shown in block diagram of FIG. 2, a MEMS based (Micro-Electro-Mechanical Systems) sensor 16 (or other accelerometer-based sensor) which in this embodiment functions as an incline or pitch sensor when augmented with physical acceleration information as sensed through the wheel speed or a GPS module. The MEMS sensor is mounted at any suitable location on the bicycle 10. The augmented sensor 16 provides an output in the form of analogue or digital signals which describe or define the direction and magnitude of the gravitational force applied to the sensor 16 and thus inclination, assuming the bicycle is not accelerating. Preferably the sensor 16 is a two- or three-axis device to achieve the accuracy required and to allow a software zero calibration rather than a hardware adjustment.

In this embodiment the sensor 16 is incorporated in and is part of the control system 14 but may be separate from the control, system 14. The sensor 16 is used to sense the angle of inclination of an upright bicycle 10 in the fore-and-aft direction so as to detect when the bicycle is travelling up a slope or hill or when it is travelling on a level area or road or down a slope or hill.

The MEMS sensor 16 has been implemented because of the requirement to quickly and accurately determine, the acceleration signal in real time. The control system 14 can only function property if the acceleration sensor 16 output, is able to accurately track the acceleration calculated by the differentiation, of the speed signal in real time. When the bicycle is travelling on a level surface, the augmented inclination should indicate zero regardless of the acceleration or deceleration of the bicycle. To permit, the sensor to be mounted in an arbitrary position on a bicycle art algorithm may be employed to determine and store in non-volatile memory the mounting angle and direction of the sensor.

To determine the bicycles angle, the relevant outputs of a 3 axis MEMS type accelerometer 16 are applied to a rotational matrix to provide an X_{bike} value, which is aligned to the horizontal plane, and zero on a level surface at test, and a Y_{bike} value which is aligned to the vertical axis, and is 1 g when located on a horizontal surface and at rest. In order to determine the inclination without the influence of acceleration, both the acceleration in the X and Y axes must be calculated. This can be performed by a 3 axis MEMS type accelerometer 16 or alternatively two single axis accelerometers or a single dual axis accelerometer may be used.

To achieve this an algorithm 38 accepts the two accelerometer outputs, and performs an algebraic rotation computation. The following equations may be used:

$$[ \begin{matrix}{X}_{bike} \\ {Y}_{bike}\end{matrix} ] = [ \begin{matrix}cos ∅ & - sin ∅ \\ sin ∅ & cos ∅\end{matrix} ] [ \begin{matrix}{X}_{accel} \\ {Y}_{accel}\end{matrix} ]$$

Where Ø is the physical angle of the accelerometer 16 when the bicycle 10 is on a level surface at rest The term Ø is calculated at the time of learning using the following computation:

$$∅ = atan \frac{{X}_{accel}}{{Y}_{accel}}$$

Since the system is intended to enable retrospective installation on a variety of bicycle frames, where it is desirable that the system can accommodate either a clockwise or anticlockwise mounting direction. Software switch 40 allows the X_{bike} term to he multiplied by −1 using a software multiply function 39 to accommodate the different mounting possibilities. The state of this switch is stored in non-volatile memory.

In this embodiment the switch state is determined after learning the offset angel Ø by requesting the rider to raise the front wheels of the bicycle to a near vertical position. If the term X_{bike} has a substantial positive value the mounting direction switch may be left in position 41. Alternatively if the term X_{bike} has a substantial negative value the mounting direction switch should be set to position 42. Note that the switch may be either a hardware device or implemented in software.

The bike's physical acceleration is determined, by differentiating 47 the velocity signal 46 using information from the bikes motor controller 20 or other velocity sensing device. This may be derived in a number of ways from the motor controller 20 in the case of a brushless motor, or alternatively from a tachometer attached to the motor 13. Alternatively a GPS receiver may be used to provide velocity data. Alternatively a frequency sensing device attached to one of the wheels may provide velocity data. The speed signal needs to be sealed to deliver the bikes velocity signal in m/s and then, differentiated to provide a term describing the physical acceleration of the bicycle in the horizontal plane. The velocity term is to be scaled by the inverse of the acceleration of a body affected by gravity, namely 1/g.

The computed acceleration needs to be subtracted 48 from the horizontal or X component of the rotated acceleration sensed by the accelerometer 16. The resulting vector components should be filtered to eliminate and remove the effects of vibration and noise using suitable filters 43, 44 of which there are many available types including but not limited to an Infinite Impulse Response filter. A filter is a well known algorithm or device for removing part(s) of a signal. In this application a filter, is taken to mean, an electronic circuit which processes signals, to remove unwanted frequency components. Preferably, the filter is a digital filter that performs mathematical operations to reduce or enhance certain aspects of a signal. For example, a digital infinite impulse responses (IIR) filter whose impulse response (or response to any finite length input) is of infinite duration, because it settles to zero in infinite time. Such fillers have desirable qualities when they used within control loops.

Finally, the resulting vector components may be applied to an ATAN function 45 to determine the angle that the bike 10 is currently experiencing. Note that the exact type of ATAN routine needs to give negative results when a negative value is applied to the function. It should be realized that the present calculation methods are by way of example only and should not be limiting to the scope of the invention.

In accordance with an embodiment of the present invention it has become apparent that it is important to control the power to the motor 13 based on an accurate measurement of the inclination of the hill. The motivations for doing this are as follows:
The provision of power only when the bicycle 10 is on an incline reduces the power consumption from the battery 15 when assistance is not required;
Unlike other sensing schemes such as torque sensing, no modification of the bicycle 10 frame is required and a simple motor 13 construction, is possible; and
The use of inclination sensing 16 removes the need to have any controls that the user may wish to alter while riding, further simplifying the system.

The power required to raise a mass tip an incline or slope is in direct proportion to inclination angle (for a constant mass and velocity). If the output power provided by the electric motor 13 is regulated according to the function P=k □, it is possible for a rider of the bicycle 10 to ascend a hill or incline without providing any additional pedalling power.

For small angles of inclination (<10 degrees), the power P required, to raise a bicycle and rider of mass M up a slope of angle □ at a speed “v” is given by the equation:

Pout=k.□.M.ν

If the speed “ν” is chosen to be a comfortable speed, say 15 km/hr and the average mass “M” of the bicycle and rider is 100 kg, then the equation reduces to approximately:

Pout=68×□

where Pout=motor output power (w) and

□=inclination (degrees)

If the efficiency of the motor is approximately 75%, then the equation describing the input power to the motor becomes approximately;

Pin=91×□, with the figure “91” representing the gain, term “k”.

Other gain terms may be established using the above equation to accommodate different rider and bicycle weights, different intended cycling speeds or different motor efficiencies.

In practice it has been found that providing 80 w of power per degree of inclination is sufficient for most riders between 60 to 90 kg on a 20 kg bike. This will enable a bicycle to ascend most hills at about 15 km/hr without the rider providing any further effort than they would have applied on a level road.

Thus to control the electric power assistance motor 13 of the bicycle 10 in accordance with the above equation, the control system has a scaler 19 which scales the angle of inclination □ by the gain term “k” and which provides an output which is the input power required to be supplied to the motor 13 for the motor 13 to provide the required power assistance for any degree of inclination, or slope encountered by the bicycle 10. As illustrated in FIG. 2 the construction of the scaler 19 would be a matter of ordinary skill and knowledge for a person skilled in the art of electronics. For example a scaler 19 in the case of a digital system is merely a mathematical multiply operation. If the circuit was achieved by analog means, a resistive divider might be used. For use of the calculated output from the scaler 19, the control system 10 includes a motor controller 20 which by pulse width modulation controls the supply of power from, the battery 15 to the motor 13. The controller 20 is arranged in a control loop with a comparator 21 which compares the actual power drawn by the motor 13 with the required power input to the motor 13 as calculated by the scaler 19.

For this comparison, the motor controller 20 determines the actual power drawn by the bicycles motor 13 by measuring both the voltage and current 29. The product of the voltage and current is the actual power used by the motor 33 and comprises a first input (Pin) to the comparator 21. The comparator 21 also receives a second input from the scaler 19 which is the scaled output referred to above which is proportional to the angle of inclination of the bicycle 10. The comparator 21 provides an output which comprises a comparison of the inputs from the motor controller 20 and scaler 19. This output is an error signal which is applied to the motor controller 20. The motor controller 20 adjusts the power supplied to the motor 13 from the battery 15 in accordance with the error signal to thereby control the commanded rotational velocity of the motor 13. Control of power supply to the motor 13 from the motor controller 20 is achieved by altering the width of the voltage pulses of the pulse width modulated signal applied to the motor 13 in accordance with the error signal from the comparator 21.

Different gain terms “k” calculated in accordance with the size of the motor 13, the bicycle 10 and rider weights and intended cycling speeds may be software programmed into the scaler 19 of the control system 14 if necessary.

The control system 14 also includes a pedaling sensor 23 which is connected to the motor controller 20 and which detects the movement of the pedals 11 and which provides an input to the motor controller 20. If the pedalling sensor 23 senses that the rider is attempting to stop or slow down by for example the rider stops pedalling the motor controller 20 will stop power supply to the motor 13. This also further removes the need for the rider to switch the motor 13 or control system 14 on or off when at traffic lights or approaching obstacles. The pedalling sensor 23 also allows the rider to coast without accelerating.

In some countries certain requirements have been set in order for electric bicycles to be legally ridden on roads. For example, in the United Kingdom the Department of Transport require that electric bikes be limited to a motor capable of a maximum of 250 W continuous power and are limited to a maximum assisted speed of 25 kmph. It is also a requirement that all electric bikes must have a pedal sensor which cuts the motor when, the rider stops pedalling.

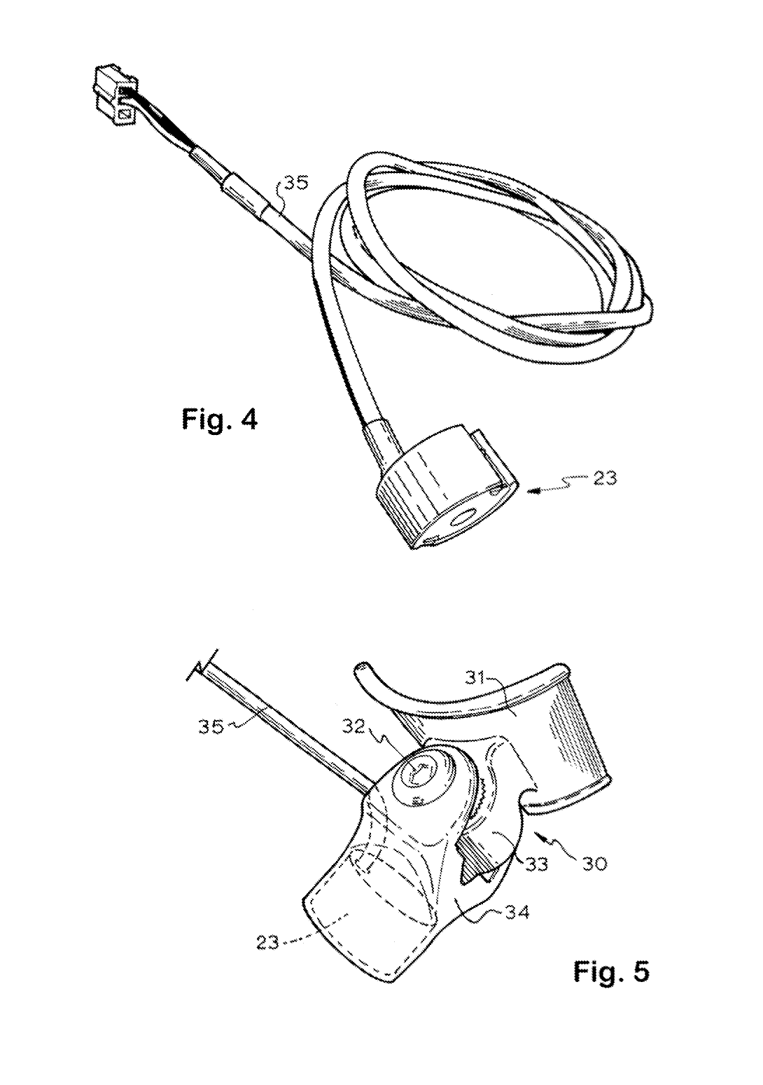

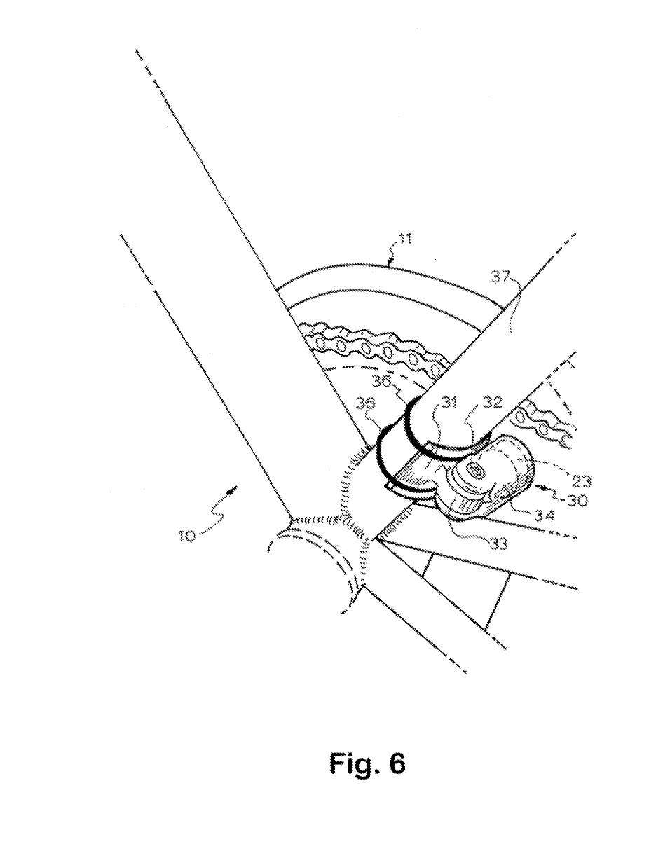

The pedalling sensor 23 is used to ensure that the motor 13 is only driven when, the rider is actually pedalling. This is necessary for safety, efficient battery usage as well as for regulators reasons in certain countries. The pedalling sensor 23 shown in FIGS. 4 to 6 is an induction coil mounted in a ferrite core, with an open end to permit the induction coils inductance and any variation in inductance (or loss) to be altered by neighbouring metals. Alternatively a hail effect sensor or a reed switch and one or more rotating magnets may be used to provide the pedalling signal. While this type of sensor has been described it should be apparent to a person skilled in the art that other types and configurations of sensors may be used.

The device 23 shown in FIGS. 4 to 6 would typically be placed in an oscillator circuit such as the Colpitis oscillator. Such a configuration will provide a change in oscillation amplitude due to the introduction of the lossy material of the magnetic circuit. This change in amplitude of the high frequency oscillation, will, be converted to a DC level by a diode pump at the output of the oscillator. This DC level is applied to an analogue or digital processing circuit: to determine the condition of the rotating pedal 11. The processing system detects the slow variations of the DC level with respect to time in order to determine if the rider is rotating the pedals of the bicycle,

In order to allow the system to fit retrospectively, it is desirable to have a system that can be universally used on many different hikes 10 without requiring the modification of the existing bicycle as existing systems using magnetic system require. In order to allow the system to be retrofitted to different bicycles 10, a bracket 30 has been developed which allows the user to install the pedalling sensor 23 easily as shown in FIG 5. The pedalling sensor 23 is attached to the seat tube 37, or other suitable components of the bicycle using cable ties 36 or other fastening devices. The sensor 23 is then adjusted by rotating the body portion 34 around the fixed portion 33 until the sensor 23 is in the correct position for sensing the rotation of the chain ring or pedals 11. The screw 32 is then tightened to fix the sensor 23 in this position. In order to mount the sensor 23 in a manner that allows the chain ring 11 to affect the properties of the coil, the ferrite coil device is inserted in the housing 34 which may be mounted in a variety of different mounting scenarios and geometries. The cable 35 attached to the pedalling sensor 23 is then attached to the control system 14. The pedal sensor 23 is thus attached to the bike frame 37 and does not move. The sensor 23 senses the movement of the pedals 11 without need to use any additional components since the chain ring or oilier parts of the existing bicycle will influence the sensor and enable detection, of pedals movement.

The present system does not require any further hardware or software to perform the required operation of providing power only when the bicycle 10 is on an incline. This satisfies the requirement of reducing power consumption from the battery 15 when assistance is not required.

In accordance with a further embodiment the present invention for activating and deactivating the system 14, the bicycle 10 is equipped with a master control on-off switch 22 typically provided on the handlebars of the bicycle 10 (see FIG. 1). This switch may be located anywhere on the bicycle since the rider is not required to operate this switch regularly.

When the bicycle 10 is being ridden on a level or flat road or path without any incline, there will, be no error signal from the scaler 19. So that power can also be applied by the motor 13 in these circumstances, the motor controller 20 has an input which can receive an offset signal 24. The offset signal 24 is a small deviation or bias in a voltage or current. When an offset signal 24 is applied to the input, the motor controller 20 will provide power to the motor 13. This will thus enable a rider of the bicycle 10 to gain power assistance from the motor 13 on flat roads or other level ground. Typically the offset 24 causes the motor controller 20 to supply a relatively low power to the motor 13 for example fifty (50) watts. The offset 24 may be selectively adjustable during riding of the bicycle 10 however it is preferred that the offset 24 is only changed in a set up mode of the bicycle 10.

The angle of inclination sensed by the inclination sensor 16 may be an angle in opposite directions depending upon whether the bicycle 10 Is travelling up a bill or slope or down a hill or on a down slope. The control system 14 interprets a downhill slope as a negative inclination and no inclination as a zero and accordingly causes the motor controller 20 to reduce power to the motor 13 to zero or to a low level where an offset is used as above.

The present invention thus provides a system 14 which enables the greatest, use of the available energy from the battery 15 since riders do not input more power than is actually required on level ground.

The control system 14 may be incorporated in new power assisted bicycles, tricycles or any other manually propelled vehicles or retrofitted into existing bicycles, tricycles or other vehicles. The control system may be embodied in a single Digital Signal Processor or formed by individual discrete components.

In use and in order to calibrate the system the mounting angle of the accelerometer 16 needs to be determined. This may be done automatically by the control system 14 in accordance with the first embodiment or manually in accordance with the second embodiment (the system which has the on/off switch 22) as described below.

In order to manually calibrate the system, and determine the mounting angle of the accelerometer 16 the on/off switch 22 is depressed for several seconds to firstly learn the angle of mounting, followed by the user raising the front wheel of the bike 10 to a near vertical position. The control, system 14 them selects the correct orientation option, for the accelerometer 16.

### Advantages

It is very desirable to minimise the drain from the battery of an electric bicycle, since this leads to the possibility of reducing the batteries capacity for a given range. This leads to significant reductions in overall weight, as well as either a reduction in battery cost or providing the manufacturer freedom to use cells of better quality in spite of higher individual cell cost. To this end it is desirable that the power provided to the motor be reduced to the occasions that the rider is most likely to benefit from it namely when he or she is travelling up a hill. It is very desirable that the power provided on a level, surface is minimized, and that level of assistance provided is proportional to the gradient of the hill being climbed,

The angle of inclination of even a large hill is actually quite small: as an example a 5 degree incline would be considered an imposing hill to climb. In addition the bicycle will experience considerable instantaneous accelerations during normal riding, for example changes of 5 m/s would not be unusual when the rider starts pedalling from a standstill. These conditions place a demanding requirement for any system that is intending to control the motors power by way of inclination. The system described uses the horizontal component of an accelerometer to accurately determine forward acceleration, which is in turn countered by acceleration computed by the change in velocity of the wheel. The small difference between those two large signals is proportional to the inclination of the hill being ascended. For this system to be effective, the accelerometer must provide its measurements with a high degree of linearity and possess a fast response time. Other methods of sensing angle such as by a mass hanging from a rotating bearing are very unlikely to be capable of meeting these demands, and will result in a unstable and therefore unusable system.

Another advantage of the present invention is to provide a system which could be easily retrofitted to existing bicycles. This required that the sensing devices must be able to function in a variety of mounting locations and orientations with minimal modification to the existing bicycle. The accelerometer arrangement achieves this goal, since it may be mounted in an arbitrary orientation and taught the zero degree position. In addition the accelerometer may be mounted in either direction of rotation and be taught the direction of rotation of the accelerometer corresponding to a rising incline. Further the pedalling sensor is able to detect the movement of the pedals without recourse to the installation of slotted optical disks or systems using magnets, hail sensors or reed switches. The system proposed may be retrofitted to a very large variety of existing bicycles without modification or removal, of pedals or other components.

### Variations

The terms “comprising” or “comprises” as used throughout the specification and claims are taken to specify the presence of the stated features, integers and components referred to but not preclude the presence or addition of one or more other feature/s, integer/s, components or group thereof.

While the above has been given, by way of illustrative embodiment of the invention, all such variations and modifications thereto as would be apparent to persons skilled in the art are deemed to fall within the broad scope and ambit of the invention as herein defined in the appended claims.

1-32. (canceled)

33. A control system for a power assisted vehicle having an electric motor, said control system including:
an accelerometer-based tilt sensor augmented with an input from a velocity source to determine the inclination of said vehicle;
a manual input variably adjustable sensor for detecting in a non-contact manner manual propulsion input to said vehicle, by sensing the rotation speed of a rotating portion of said vehicle; and
said control system being adapted to control the power supplied to said motor and therefore the power assistance provided to said vehicle by said electric motor in accordance with the inclination or pitch of said vehicle as sensed by said augmented accelerometer-based tilt sensor and the manual propulsion input from said manual propulsion sensor.

34. A control system as claimed in claim 33, wherein said accelerometer-based tilt sensor is a multi-axis MEMS sensor for sensing acceleration in at least two axes in a coordinate system to determine the inclination of said vehicle.

35. A control system as claimed in claim 34, wherein the augmented input from the velocity source is converted to physical acceleration information for augmenting the multi-axis MEMS sensor to determine the inclination of said vehicle.

36. A control system as claimed in claim 35 and including a comparator for comparing the power drawn by said motor with the power input required to be supplied to the motor determined from an output signal or signals from said sensor, and a motor controller, wherein said comparator provides an error signal from said comparison, said motor controller being adapted to vary the power supplied from a battery to said motor in accordance with said error signal.

37. A control system as claimed in claim 36 and including means for scaling said output signal or signals from said sensor in accordance with one or more of the an average weight of the vehicle, an average weight of a rider of the vehicle, the intended speed of the vehicle and efficiency of the motor.

38. A control system as claimed in claim 33, wherein said manual input variably adjustable sensor is an induction sensor mounted in an infinitely variable and adjustable housing in a manner that allows the rotating portion to affect the properties of the induction sensor in a variety of different mounting positions.

39. A control system as claimed in claim 38, wherein the induction sensor is an induction coil mounted in a ferrite core, with an open end to permit the induction coils inductance and any variation in inductance to be altered by the rotating portion.

40. A control system as claimed in claim 39, further including a switch for turning the control system on and off, wherein depressing the switch for a finite period of time allows the control system to automatically determine the mounting angle of the MEMS sensor.

41. A control sensor as claimed in claim 40, further including determining the mounting orientation of the MEMS sensor by a user raising the front wheel of the vehicle to a near vertical position to allow the control system to select the correct orientation for the vehicle.

42. A power assisted bicycle or tricycle, said bicycle or tricycle having at least a front wheel and a rear wheel, pedals for application of a pedaling force to at least one of said wheels for manually propelling said bicycle or tricycle, an electric motor on said bicycle or tricycle for providing supplementary drive to one of said wheels, and a control system for controlling the power supply to said electric motor, said control system comprising:
an accelerometer-based tilt sensor augmented with an input from a velocity source to determine the inclination of said bicycle or tricycle in a fore and aft direction to thereby sense whether said bicycle or tricycle is climbing an incline, traveling with no inclination on level ground, or moving down an incline and the degree of said inclination;
a pedalling sensor for sensing the rotation of a pedal assembly of said bicycle or tricycle; and
a motor controller for controlling power supply to said electric motor, said motor controller being adapted to vary the power supply to said motor and therefore the power assistance provided to said bicycle or tricycle by said motor in accordance with the inclination of said bicycle or tricycle as sensed by said augmented accelerometer-based tilt sensor and the output of the pedalling sensor when pedalling is sensed.

43. A power assisted bicycle or tricycle as claimed in claim 42, wherein said accelerometer-based tilt sensor is a multi-axis MEMS sensor for sensing acceleration in at least two axes in a coordinate system to determine the inclination of said vehicle.

44. A power assisted bicycle or tricycle as claimed in claim 43, wherein the augmented input from the velocity source is converted to physical acceleration information for augmenting the multi-axis MEMS sensor to determine the inclination of said vehicle.

45. A power assisted bicycle or tricycle as claimed in claim 44, wherein said MEMS sensor provides an output signal, and wherein said control system includes means for filtering and processing said output signal for filtering external vibration signals from said output signal, and said control system includes means for scaling said filtered and processed output signal from said MEMS sensor, wherein said scaling means scales said filtered and processed signal from said MEMS sensor in accordance with a gain term determined by one or more of the average weight of the bicycle or tricycle, the average weight of the rider of the bicycle or tricycle, the intended speed of the bicycle or tricycle and efficiency of the motor.

46. A power assisted bicycle or tricycle as claimed in claim 47, and including a comparator for comparing said scaled filtered and processed signal from said MEMS sensor with power drawn by said motor to provide an output error signal and wherein said motor controller supplies power from said battery to said motor in accordance with said error signal.

47. A power assisted bicycle or tricycle as claimed in claim 46, wherein said motor controller provides a pulse width modulated power signal to said motor and wherein the pulse width of said signal is varied in accordance with said error signal, and including means for providing an offset signal to said motor controller whereby said motor controller can apply a signal to said motor when said bicycle or tricycle is traveling on level ground as sensed by said MEMS sensor.

48. A power assisted bicycle or tricycle as claimed in claim 47, wherein said pedalling sensor is an induction sensor mounted in an infinitely variable and adjustable housing in a manner that allows the pedal assembly to affect the properties of the induction sensor in a variety of different mounting positions.

49. A power assisted bicycle or tricycle as claimed in claim 48, wherein the induction sensor is an induction coil mounted in a ferrite core, with an open end to permit the induction coils inductance and any variation in inductance to be altered by the pedal assembly.

50. A power assisted bicycle or tricycle as claimed in claim 49, further including a switch for turning the control system on and off, wherein depressing the switch for a finite period of time allows the control system to automatically determine the mounting angle of the MEMS sensor.

51. A power assisted bicycle or tricycle as claimed in claim 50, further including determining the mounting orientation of the MEMS sensor by a user raising the front wheel of the vehicle to a near vertical position to allow the control system to select the correct orientation for the vehicle.

52. A method of providing power assistance to a vehicle having a power assistance electric motor comprising the steps of;
a) sensing the inclination of said vehicle using an accelerometer-based tilt sensor augmented with an input from a velocity source;
b) sensing the rotation of a pedal assembly using a pedalling sensor; and
c) controlling the power supplied to said motor and therefore the power assistance provided to said vehicle by said electric motor in accordance with the inclination of said vehicle as sensed by said augmented accelerometer-based tilt sensor and the output of the pedalling sensor when pedalling is sensed.
